(19) United States
(12) Patent Application Publication
(10) Pub. No.: US 2026/0109432 A1
(43) Pub. Date: Apr. 23, 2026

(54) Rotating Ladder for a Boat

(71) Applicant: OPACMARE S.P.A., Rivalta di Torino (Torino) (IT)

(72) Inventor: Alessandro SACCO, Orbassano (Torino) (IT)

(21) Appl. No.: 19/364,988

(22) Filed: Oct. 21, 2025

(30) Foreign Application Priority Data
Oct. 23, 2024 (IT) 102024000023580

(51) Int. Cl. B63B 27/14; E06C 1/38; E06C 1/387

(52) U.S. Cl. CPC B63B 27/146; E06C 1/381; E06C 1/387

(57) ABSTRACT

A rotating ladder for a boat has a support, a structural box beam hinged to the support and rotatable about a horizontal axis, and a plurality of pivoting steps pivoted to the structural box beam and arranged in series along the structural box beam. Each of the pivoting steps has a step structure cantilevered from the structural box beam and provided with a front wall and a rear wall connected to one another by a first support wall and a second support wall placed at different distances from the structural box beam. A pivot pin connecting the step structure to the structural box beam is inserted into a first hole and into a second hole formed in the first and second support walls, respectively. A buffer fixed to the first support wall and arranged below the pivot pin is abutting against a side wall of the structural box beam.

### CROSS-REFERENCE TO RELATED APPLICATION

This application claims priority to Italian Patent Application No. 102024000023580 filed Oct. 23, 2024, the contents of which are hereby incorporated by reference in their entirety.

### FIELD OF THE INVENTION

The present invention relates to a rotating ladder for a boat, of the type comprising a support,
a structural box beam hinged to the support and rotatable about a horizontal axis, and
a plurality of pivoting steps pivoted to the structural box beam and arranged in series along the structural box beam.

### SUMMARY OF THE INVENTION

An object of the present invention is to provide a relatively compact and lightweight solution.

In view of this object, the subject matter of the invention is a rotating ladder of the type described above, wherein each of the pivoting steps comprises a step structure cantilevered from the structural box beam, the step structure comprising a front wall and a rear wall connected to one another by a first support wall and a second support wall placed at different distances from the structural box beam, wherein a pivot pin connecting the step structure to the structural box beam is inserted into a first hole and into a second hole formed in the first support wall and in the second support wall, respectively, and wherein a buffer fixed to the first support wall and arranged below the pivot pin is abutting against a side wall of the structural box beam.

Each of the steps is therefore supported by the pivot pin and the buffer, which exert a direct mechanical reaction on the structural box beam. The box beam thus operates as the only load-bearing element of the entire system, supporting the step structure by means of the pivot pin and the buffer, thereby releasing the other components of the kinematic mechanism from structural functions. This configuration allows a significant reduction of the overall mass, while maintaining the effectiveness of the system. The distribution of forces is therefore concentrated on the box beam, optimizing the overall weight and ensuring a compact and lightweight mechanical system.

### BRIEF DESCRIPTION OF THE FIGURES

Features and advantages of the rotating ladder according to the present invention will become clearer with the following detailed description of an embodiment of the invention, made with reference to the accompanying drawings, provided purely by way of illustration and not limitation, in which:

FIG. 1 is a perspective view of a rotating ladder according to the present invention;

FIG. 2 is a plan view of the rotating ladder of FIG. 1;

FIG. 3 is a sectional view of the rotating ladder, taken along line A-A of FIG. 2; and

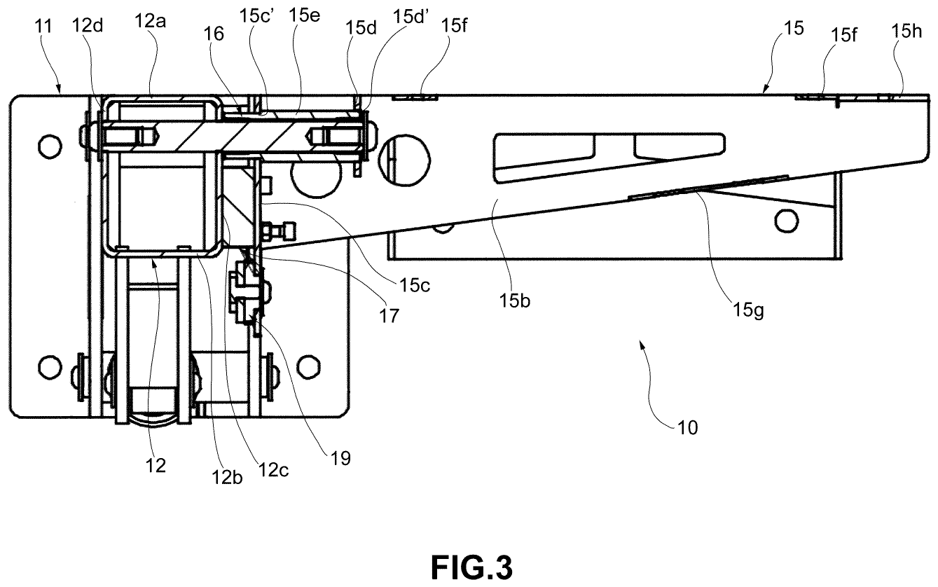

FIG. 4 is a further perspective view of the rotating ladder of FIG. 1.

### DETAILED DESCRIPTION

In the figures, a rotating ladder for a boat is denoted overall by number 10. The spatial references used in the description that follows refer to the condition of use of the rotating ladder.

The rotating ladder 10 comprises a support 11, adapted to be fixed to a structure of the boat (not illustrated).

The rotating ladder 10 further comprises a structural box beam 12 hinged to the support 11 and rotatable about a horizontal axis x. An actuator 13 may be mounted on the support 11 and connected to the structural box beam 12, the actuator 13 being operable to rotate the structural box beam 12 about the horizontal axis x.

The structural box beam 12 extends along the extension direction of the rotating ladder, and comprises an upper wall 12a, a lower wall 12b, and a pair of side walls 12c, 12d connecting the upper wall 12a and the lower wall 12b to one another.

The rotating ladder 10 further comprises a plurality of pivoting steps 14 pivoted to the structural box beam 12 and arranged in series along the structural box beam.

Each of the pivoting steps 14 comprises a step structure 15 cantilevered from the structural box beam 12. The step structure 15 comprises a front wall 15a and a rear wall 15b connected to one another by a first support wall 15c and a second support wall 15d placed at different distances from the structural box beam 12.

A pivot pin 16 connecting the step structure to the structural box beam 12 is inserted into a first hole 15c′ and into a second hole 15d′ formed in the first support wall 15c and in the second support wall 15d, respectively. More precisely, the pivot pin 16 is inserted into a sleeve 15e fixed to the first support wall 15c and to the second support wall 15d, respectively at the first hole 15c′ and the second hole 15d′.

The pivot pin 16 extends from the step structure 15 through a hole formed in the side wall 12c of the structural box beam 12 closest to the step structure 15, and then through a hole formed in the side wall 12d of the structural box beam 12 furthest from the step structure 15. The side walls 12c and 12d of the structural box beam 12 thus support the pivot pin 16. The sleeve 15e extends from the step structure 15 up to contact with the side wall 12c of the structural box beam 12 closest to the step structure 15.

A buffer 17 of material with a low friction coefficient is fixed to the first support wall 15c of the step structure 15 and arranged below the pivot pin 16. The buffer 17 is abutting against the closest side wall 12c of the structural box beam 12.

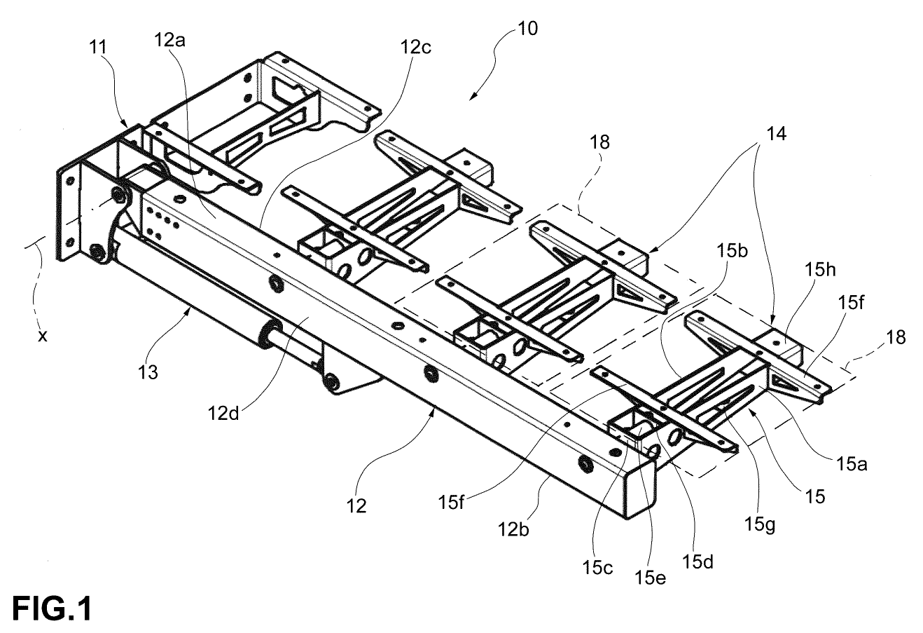

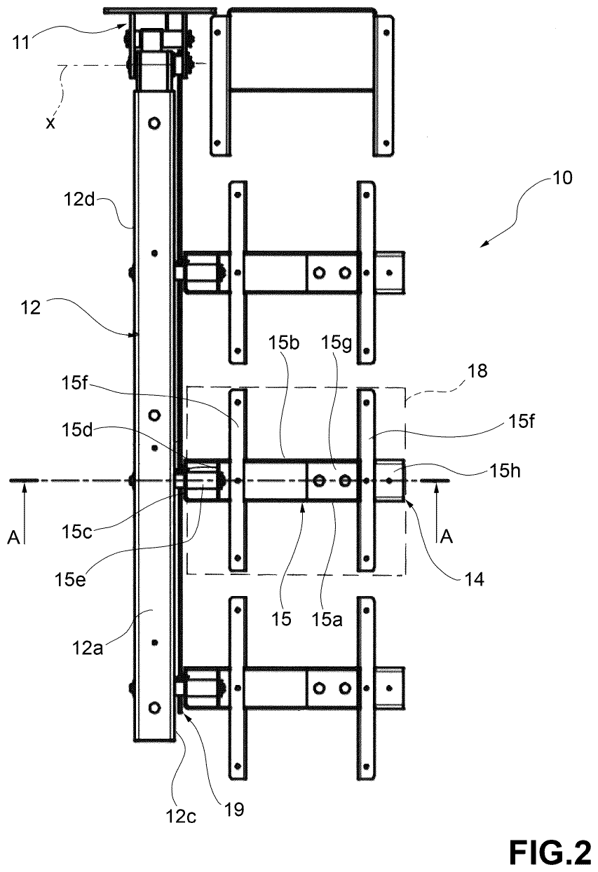

The front wall 15a and the rear wall 15b are further connected to one another by at least one upper support member 15f configured for fixing a step surface 18, represented by broken lines in FIGS. 1 and 2. In addition, the front wall 15a and the rear wall 15b may be connected to one another by further connecting members 15g, 15h formed enbloc with them or fixed to them to increase the mechanical strength of the step structure 15.

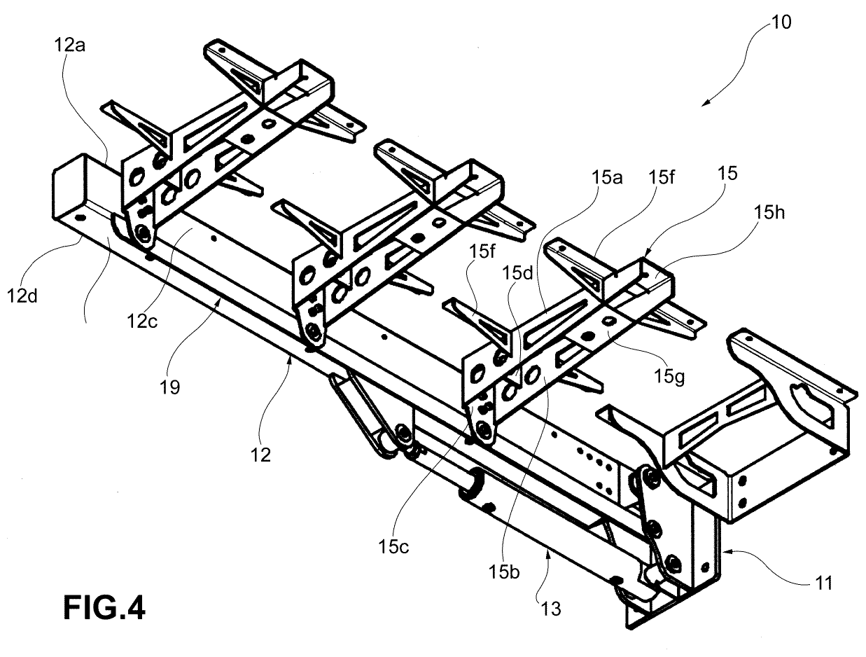

Conventionally, a transmission mechanism 19 (shown in particular in FIG. 4) is provided, which connects the steps to the support 11, and which in the illustrated example is a pantograph mechanism. Said mechanism serves to maintain the steps at a fixed orientation with respect to the support 11, in particular in a horizontal arrangement, regardless of the angle of inclination assumed by the structural box beam 12 in its rotation about the axis x. According to alternative embodiments, not illustrated, the transmission mechanism may comprise gear wheels and a chain or belt coupled to the gear wheels. The particular construction of the transmission mechanism is not essential for the purposes of the present invention.

What is claimed is:

1. A rotating ladder for a boat, comprising:
a support,
a structural box beam hinged to the support and rotatable about a horizontal axis, and
a plurality of pivoting steps pivoted to the structural box beam and arranged in series along the structural box beam,
wherein each pivoting step of the plurality of pivoting steps comprises a step structure cantilevered from the structural box beam, the step structure comprising a front wall and a rear wall interconnected by a first support wall and a second support wall placed at different distances from the structural box beam, wherein a pivot pin that connects the step structure to the structural box beam is inserted into a first hole and into a second hole formed in the first support wall and the second support wall, respectively, and wherein a buffer attached to the first support wall and arranged below the pivot pin is leaning on a side wall of the structural box beam.

2. The rotating ladder of claim 1, further comprising an actuator mounted to the support and connected to the structural box beam, the actuator being operable to rotate the structural box beam about the horizontal axis.

3. The rotating ladder of claim 1, wherein the front wall and the rear wall are further connected to each other by at least one upper support member configured for attaching a step surface.

4. The rotating ladder of claim 1, wherein the pivot pin is inserted into a sleeve attached to the first support wall and to the second support wall at the first hole and at the second hole, respectively.

5. The rotating ladder of claim 4, wherein the sleeve extends from the step structure and has an end contacting the side wall of the structural box beam closest to the step structure.

6. The rotating ladder of claim 1, wherein the pivot pin extends from the step structure through a hole formed in the side wall of the structural box beam closest to the step structure, and through a hole formed in the side wall of the structural box beam furthest from the step structure.
